(19) United States
(12) Patent Application Publication
(10) Pub. No.: US 2020/0072635 A1
(43) Pub. Date: Mar. 5, 2020

(54) ALERT SYSTEM AND A METHOD OF ALERTING A USER DISPOSED ON A SEAT

(71) Applicant: GM Global Technology Operations LLC, Detroit, MI (US)

(72) Inventors: Sharon Hornstein, Pardes Hanna (IL); Claudia V. Goldman-Shenhar, Mevasseret Zion (IL)

(73) Assignee: GM Global Technology Operations LLC, Detroit, MI (US)

(21) Appl. No.: 16/117,599

(22) Filed: Aug. 30, 2018

(51) Int. Cl. G01C 21/36; B60N 2/00; B60N 2/24

(52) U.S. Cl. CPC G01C 21/3652; G01C 21/3697; B60N 2/24; B60N 2/002; G01C 21/3667

(57) ABSTRACT

A method of alerting a user includes storing data regarding a plurality of inputs via a controller having a memory and a processor, and determining if a predetermined threshold is reached in light of the inputs. The method also includes activating an indicator of a seat when the predetermined threshold is reached to alert the user.

An alert system includes a seat. The seat includes an indicator. The alert system also includes a controller in communication with the indicator. The controller includes a processor and a memory having recorded instructions for alerting a user. The controller is configured to store data regarding a plurality of inputs and determine if a predetermined threshold is reached in light of the inputs. The controller is also configured to activate an indicator of a seat when the predetermined threshold is reached to alert the user.

### INTRODUCTION

Vehicles typically include a passenger compartment accessible by one or more doors. Generally, vehicles include one or more seats and an instrument panel. A passenger sits on one of the seats, and depending on the amount of time sitting on the seat, the passenger may become uncomfortable.

### SUMMARY

The present disclosure provides a method of alerting a user disposed on a seat. The method includes storing data regarding a plurality of inputs via a controller having a memory and a processor, and determining if a predetermined threshold is reached in light of the inputs. The method also includes activating an indicator of the seat when the predetermined threshold is reached to alert the user.

The method optionally includes one or more of the following:

A) the indicator includes a massage apparatus coupled to the seat, and the massage apparatus is configured to move the seat;

B) activating the indicator includes moving the seat in response to activation of the massage apparatus when the predetermined threshold is reached;

C) the seat includes a lumbar region and a bottom region transverse to the lumbar region

D) the massage apparatus is coupled to at least one of the lumbar region and the bottom region;

E) moving the seat includes moving at least one of the lumbar region and the bottom region of the seat in response to activation of the massage apparatus when the predetermined threshold is reached;

F) moving the seat includes moving both of the lumbar region and the bottom region of the seat in response to activation of the massage apparatus when the predetermined threshold is reached;

G) the seat is disposed in a passenger compartment of a vehicle;

H) the inputs include at least one of a weight, a height and a position of the seat;

I) communicating a first stop location from a navigation system to the controller; J) monitoring a current location of the vehicle from the navigation system to the controller after communicating the first stop location;

K) the predetermined threshold includes a predetermined duration of time the vehicle travels from the first stop location;

L) communicating to a notification assembly an upcoming location to stop the vehicle when the predetermined duration of time is reached;

M) determining, upon reaching the upcoming location, whether the vehicle stopped at the upcoming location;

N) communicating a second stop location if the vehicle stopped upon reaching the upcoming location;

O) determining whether another stop is required if the predetermined duration of time is reached after reaching the second stop location;

P) communicating to the notification assembly another upcoming location to stop the vehicle when the predetermined duration of time is reached after reaching the second stop location;

Q) communicating to the notification assembly another upcoming location to stop the vehicle if the vehicle bypassed the upcoming location;

R) the notification assembly includes a display, and wherein communicating to the notification assembly the upcoming location to stop includes displaying the upcoming location on the display;

S) the notification assembly includes a speaker, and wherein communicating to the notification assembly the upcoming location to stop includes vocalizing the upcoming location on the speaker;

T) storing an ending location of the vehicle in the navigation system;

U) the predetermined threshold includes a predetermined duration of time the vehicle travels between the first stop location and the ending location, and communicating to a notification assembly an upcoming location to stop the vehicle when the predetermined duration of time is reached;

V) determining whether another stop is required after reaching the second stop location;

W) communicating to the notification assembly another upcoming location to stop the vehicle after reaching the second stop location;

X) the predetermined threshold includes a set duration of time;

Y) storing data regarding an amount of time the indicator is activated and an amount of intensity of the indicator;

Z) activating the indicator of the seat includes activating the indicator when the set duration of time passes after the first stop location;

AA) determining whether another activation of the indicator is required after activating the indicator when the set duration of time passes;

BB) determining a location to stop the vehicle when the predetermined threshold is reached;

CC) announcing the location to stop the vehicle via a notification assembly; DD) determining, upon reaching the location, whether the vehicle stopped at the location;

EE) communicating another location to stop if the vehicle bypassed the location;

and

FF) communicating to the notification assembly another location to stop the vehicle after reaching the location.

The present disclosure also provides an alert system including a seat. The seat includes an indicator. The alert system also includes a controller in communication with the indicator. The controller includes a processor and a memory having recorded instructions for alerting a user. The controller is configured to store data regarding a plurality of inputs and determine if a predetermined threshold is reached in light of the inputs. The controller is also configured to activate an indicator of a seat when the predetermined threshold is reached to alert the user.

The alert system optionally includes one or more of the following:

A) the seat includes a lumbar region and a bottom region transverse to the lumbar region, and wherein the indicator is coupled to at least one of the lumbar region and the bottom region;

B) the indicator includes a massage apparatus configured to move at least one of the lumbar region and the bottom region in response to the predetermined threshold being reached;

C) the seat is disposed in a passenger compartment of a vehicle;

D) the inputs include at least one of a weight, a height and a position of the seat;

E) a first stop location is communicated from a navigation system to the controller;

F) a current location of the vehicle from the navigation system is monitored via the controller after the first stop location is communicated to the controller;

G) the predetermined threshold includes a predetermined duration of time the vehicle travels from the first stop location; and

H) a notification assembly announces an upcoming location to stop the vehicle when the predetermined duration of time is reached.

The detailed description and the drawings or FIGS. are supportive and descriptive of the disclosure, but the claim scope of the disclosure is defined solely by the claims. While some of the best modes and other embodiments for carrying out the claims have been described in detail, various alternative designs and embodiments exist for practicing the disclosure defined in the appended claims.

### BRIEF DESCRIPTION OF THE DRAWINGS

FIG. 1 is a schematic perspective view of a vehicle that may utilize an alert system and a method of alerting a user.

FIG. 2 is a schematic illustration of part of the vehicle and the alert system.

FIG. 3 is a schematic perspective view of a seat that may utilize the alert system.

### DETAILED DESCRIPTION

Those having ordinary skill in the art will recognize that all directional references (e.g., above, below, upward, up, downward, down, top, bottom, left, right, vertical, horizontal, etc.) are used descriptively for the FIGS. to aid the reader's understanding, and do not represent limitations (for example, to the position, orientation, or use, etc.) on the scope of the disclosure, as defined by the appended claims.

The phrase “at least one of” as used herein should be construed to include the non-exclusive logical “or”, i.e., A and/or B and so on depending on the number of components.

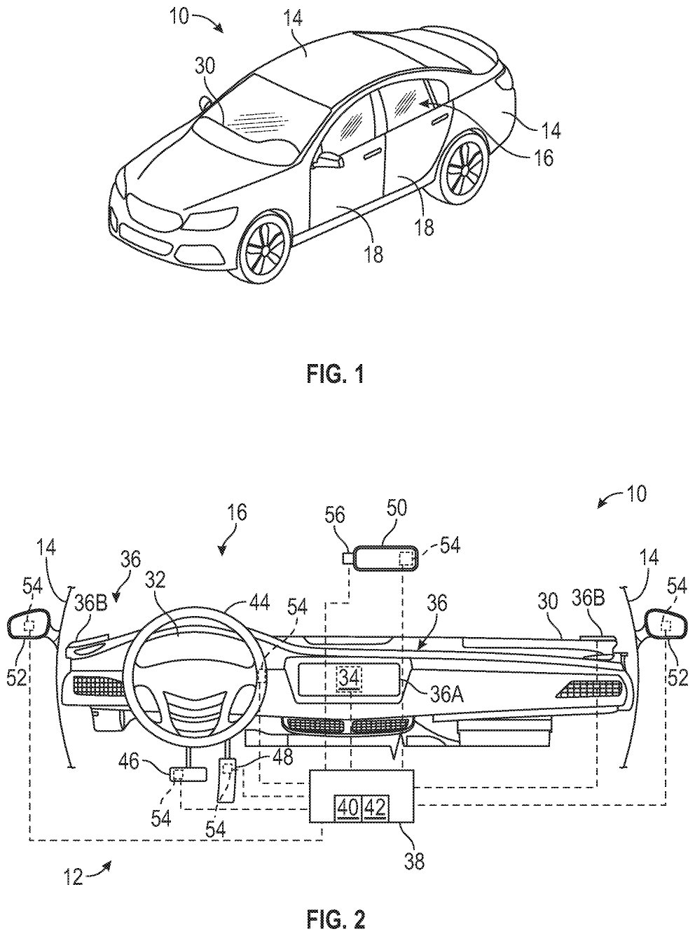

Referring to the FIGS., wherein like numerals indicate like or corresponding parts throughout the several views, a vehicle 10 is generally shown in FIG. 1. In certain embodiments, an alert system 12 may be utilized in the vehicle 10. In other embodiments, the alert system 12 may be utilized in a non-vehicle application, as noted below. The alert system 12 alerts a user. The alert may be to improve the comfort of the user. As one example discussed further below, if the user has been traveling in the vehicle 10 for an extended period of time, the alert system 12 may be configured to alert the user to change positions and/or configured to massage the user, for example, the user's back and/or legs.

Therefore, as one non-limiting example, the alert system 12 may be utilized in the vehicle 10. Non-limiting examples of the vehicle 10 may include vans, cars, trucks, recreational vehicles, boats, trains, airplanes, farm equipment or any other suitable movable platform. Additionally, the vehicle 10 may include autonomously driven vehicles 10 or vehicles 10 driven via a human. Furthermore, the vehicle 10 may be an electric vehicle 10, a hybrid vehicle 10, a traditional gas powered vehicle 10, etc. Non-limiting examples of the non-vehicle applications may include machines, farm equipment, chairs, or any other suitable non-vehicle.

For the vehicle application as shown in FIG. 1, the vehicle 10 may include a body 14 defining a passenger compartment 16. Generally, the passenger compartment 16 is accessible by one or more doors 18. Therefore, when a passenger desires to enter or exit the passenger compartment 16, the passenger opens or closes the door 18 to allow ingress or egress. As such, the door(s) 18 are movable between an open position and a closed position relative to the passenger compartment 16. FIG. 1 illustrates the doors 18 in the closed position.

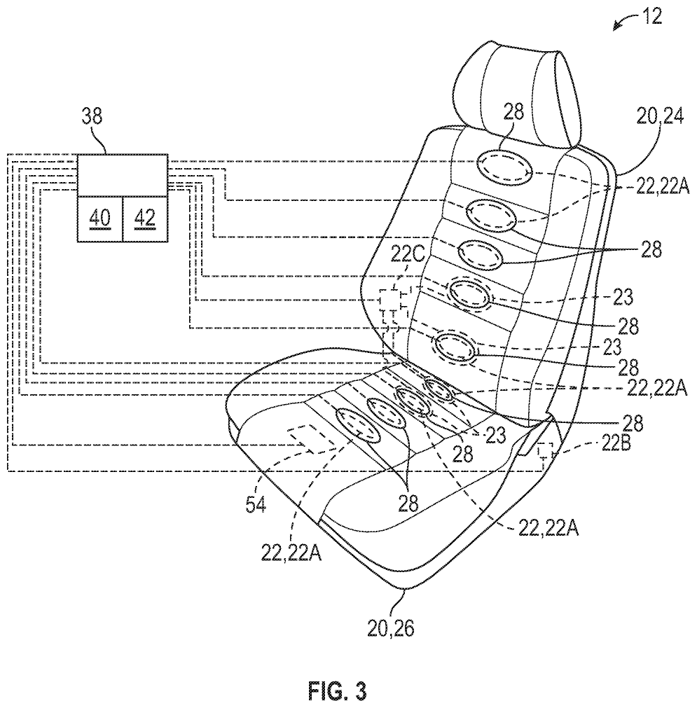

Referring to FIG. 3, the alert system 12 includes a seat 20, and in certain embodiments, the seat 20 is disposed in the vehicle 10. More specifically, the seat 20 may be disposed in the passenger compartment 16 of the vehicle 10. In certain embodiments, the vehicle 10 may include a plurality of the seats 20 disposed inside the passenger compartment 16. In other embodiments, the seats 20 may be disposed in any suitable movable platform or in a building, etc. The user may be a driver or passenger of the movable platform, or the user may be the person sitting on a seat in a building, etc.

Continuing with FIG. 3, the seat 20 includes an indicator 22. The indicator 22 alerts the user. As non-limiting examples, the indicator 22 may alert the user by moving the seat 20. If utilizing more than one of the seats 20, the seats 20 may each include a respective indicator 22. As such, more than one indicator 22 may be utilized. For example, the indicator 22 may move the seat 20 via vibration, pulses, bladders 23, and/or rollers, etc. Hence, the indicator 22 may be disposed inside the seat 20 and felt by the user through the seat 20.

Continuing with FIG. 3, the seat 20 may include a lumbar region 24 and a bottom region 26 transverse to the lumbar region 24. Generally, the lumbar region 24 may be the region that the user rests their back along and the bottom region 26 may be the region that the user sits on. In certain embodiments, the indicator 22 is coupled to at least one of the lumbar region 24 and the bottom region 26. Said differently, the indicator 22 may be coupled to the lumbar region 24, or coupled to the bottom region 26, or the indicator 22 may be coupled to both the lumbar region 24 and the bottom region 26. As mentioned above, more than one indicator 22 may be utilized, and thus, one or more indicators 22 may be coupled to the lumbar region 24, and/or one or more indicators 22 may be coupled to the bottom region 26. As additional examples, the indicator 22 may move the seat 20 to change the posture of the user via changing the orientation of the lumbar region 24 relative to the bottom region 26 and/or changing the convexity of the lumbar region 24 and/or bottom region 26. However, the indicator 22, when activated, does not move the bottom region 26 of the seat 20 back and forth longitudinally relative to the steering wheel 44. In other words, the bottom region 26 of the seat 20 does not move longitudinally closer to the steering wheel 44 or farther from the steering wheel 44 when the indicator 22 is activated.

Generally, the indicator 22 may be configured to move the seat 20, and more specifically, the indicator 22 may be configured to move at least one of the lumbar region 24 and the bottom region 26. For example, the indicator 22 may move the lumbar region 24 or the bottom region 26, or may move both the lumbar region 24 and the bottom region 26. The indicator 22 may include a motor 22B coupled to the lumbar region 24 and the bottom region 26 which changes the orientation of the lumbar region 24 relative to the bottom region 26 when activated. Said differently, when the motor 22B is activated, the entire back of the seat 20 (which includes the lumbar region 24) may move to change an angle of the back of the seat 20 relative to the bottom region 26. The indicator 22 may also include an actuator 22C coupled to one or more bladders 23 to inflate and/or deflate the respective bladders 23 to change the convexity of the lumbar region 24 and/or the bottom region 26.

In certain embodiments, the indicator 22 may include a massage apparatus 22A coupled to the seat 20, and the massage apparatus 22A is configured to move the seat 20. More specifically, the massage apparatus 22A is coupled to at least one of the lumbar region 24 and the bottom region 26, and the massage apparatus 22A is configured to move at least one of the lumbar region 24 and the bottom region 26 in response to a predetermined threshold being reached. Therefore, in certain embodiments, the massage apparatus 22A is coupled to the lumbar region 24 or the bottom region 26. In other embodiments, the massage apparatus 22A is coupled to both of the lumbar region 24 and the bottom region 26.

The massage apparatus 22A may include a plurality of zones 28 to tailor the location(s) of the seat 20 that move when the massage apparatus 22A is activated. The zones 28 may be disposed along the lumbar region 24 and/or the bottom region 26. The massage apparatus 22A may include any components to move the seat 20 as desired. Non-limiting examples of the components of the massage apparatus 22A may include one or more motors, the component(s) coupled to the motor that vibrate, pulse and/or roll, one or more rollers, one or more tracks, etc. The bladders 23 may also be disposed along one or more of the zones 28.

Referring to FIGS. 1 and 2, the vehicle 10 may include an instrument panel 30 disposed inside the passenger compartment 16. At least part of the alert system 12 may be coupled to the instrument panel 30.

Referring to FIG. 2, the instrument panel 30 may include an instrument cluster 32. The instrument cluster 32 may convey various information to the passenger of the vehicle 10, such as the speed the vehicle 10 is traveling, the amount of fuel or battery life, etc. Furthermore, the instrument panel 30 may include one or more vents, one or more compartments, one or more airbags, etc.

The alert system 12 may also include a navigation system 34. The navigation system 34 may be configured to track or monitor a current location of the vehicle 10, as well as identify one or more upcoming locations or destinations. As one non-limiting example, the navigation system 34 may include a global positioning system (GPS) and a map object classifier or any other suitable mapping system that may identify roads, streets, expressways, rest areas, gas stations, stores, entertainment venues, companies, businesses, parks, or any other locations. Therefore, the GPS may identify the location of the vehicle 10 along respective roads, streets, etc.; and the map object classifier may identify places along the roads, streets, etc., such as, the rest areas, gas stations, parks, pedestrian crossings, etc., and the identified places may be used for locations to stop the vehicle 10. The map object classifier may use map data and/or a camera to identify places along the roads, streets, etc. If using the camera of the map object classifier, the camera may identify road signs, attraction signs, building signs, etc.

Additionally, the alert system 12 may include a notification assembly 36. The notification assembly 36 may be configured to communicate with the user various information. Generally, the notification assembly 36 may communicate to the user an upcoming location to stop the vehicle 10. As one non-limiting example, the notification assembly 36 may announce the upcoming location to stop the vehicle 10 when a predetermined duration of time is reached.

In certain embodiments, the notification assembly 36 may include a display 36A, and in certain embodiments, the display 36A may be disposed in the vehicle 10. The display 36A may visually convey radio information/preferences, map information/preferences, vehicle 10 information/preferences, phone information/preferences, seat 20 preferences, alert information such as an upcoming location to stop the vehicle 10, amount of time until reaching the upcoming location to stop the vehicle 10, the expected time of arrival at the upcoming location or a final destination, the upcoming location and/or the final destination may be displayed via a map, etc. Generally, the display 36A is disposed inside the passenger compartment 16. The display 36A may be coupled to the instrument panel 30, a roof panel, a center console, etc. It is to be appreciated that the vehicle 10 may include a plurality of the displays 36A.

In certain embodiments the notification assembly 36 may include a speaker 36B, and in certain embodiments, the speaker 36B may be disposed in the vehicle 10. The speaker 36B may audibly convey information, music, alert information such as an upcoming location to stop the vehicle 10, etc. Generally, the speaker 36B is disposed inside the passenger compartment 16. The speaker 36B may be coupled to the instrument panel 30, the roof panel, the center console, the door 18, etc. It is to be appreciated that the vehicle 10 may include a plurality of the speakers 36B.

The alert system 12 also includes a controller 38 in communication with the indicator 22. The controller 38 includes a processor 40 and a memory 42 having recorded instructions for alerting the user. The controller 38 is configured to store data regarding a plurality of inputs, determine if the predetermined threshold is reached in light of the inputs, and activate the indicator 22 of the seat 20 when the predetermined threshold is reached to alert the user.

The controller 38 is also configured to store a default setting for activating the indicator 22 and the predetermined threshold. Therefore, for example, when completing the manufacturing process of the vehicle 10, the alert system 12 of the vehicle 10 may include a default setting of parameters to activate the indicator 22. The default setting may include the predetermined threshold (such as a default duration of time before activating the indicator 22) and/or the indicator 22 preferences (such as the amount of time the indicator 22 is activated, what regions 24, 26 and/or zones 28 of the seat 20 are activated, the number of times the indicator 22 is activated, the intensity of the indicator 22, etc.). If the user does not change one or more of the default settings, then the controller 38 will utilize that unchanged default setting to alert the user.

Additionally, the controller 38 may include an override setting in which a vehicle fleet manager, suitable supervisory position or owner of the vehicle 10, etc., may set the predetermined threshold (such as a default duration of time before activating the indicator 22), and/or the indicator 22 preferences (such as the amount of time the indicator 22 is activated, what regions 24, 26 and/or zones 28 of the seat 20 are activated, the number of times the indicator 22 is activated, the intensity of the indicator 22, etc.) for one or more the vehicles 10 of a fleet, etc., and/or the location(s) to stop one or more of the vehicles 10 of the fleet, etc. If the vehicle fleet manager/supervisor/owner does not change one or more of the default settings when setting the preferences in the override setting, then the controller 38 will utilize that unchanged default setting to alert the user. The user of the respective vehicle 10 may change the unchanged default settings that the vehicle fleet manager/supervisor/owner did not set in the override setting. The vehicle fleet manager/supervisor/owner may access the override setting via the display 36A in the respective vehicle 10 or externally from the respective vehicle 10 via a user interface that is in communication with the controller 38. The vehicle fleet manager/supervisor/owner may also use the user interface to monitor the respective vehicle 10 to keep track of whether the respective vehicle 10 stopped when the indicator 22 was activated, how long the respective vehicle 10 stopped, what route the respective vehicle 10 traveled, etc. Therefore, for example, the vehicle fleet manager or supervisor, etc., may keep track of the employees using the respective vehicles 10. As another example, the owner of the vehicle 10 may keep track of the user(s) of the owner's vehicle 10.

Non-limiting examples of the inputs may include at least one of a weight, a height and a position of the seat 20. Said differently, the inputs may include the weight, and/or the height, and/or the position of the seat 20. Generally, the weight is referring to the weight of the user and the height is referring to the height of the user. The position of the seat 20 may include the position of the lumbar region 24 relative to the bottom region 26, and/or the position of the seat 20 from a steering wheel 44, and/or the position of the seat 20 from a brake pedal 46, and/or the position of the seat 20 from an accelerator pedal 48, etc. Additional non-limiting examples of the inputs may include a set amount of time that passes, a set amount of time that passes between intervals of alerts, a position of a rear view mirror 50, a position of the accelerator pedal 48, a position of the brake pedal 46, a position of the steering wheel 44, a position of outside mirrors 52 or a height of the seat 20.

The alert system 12 may also include a sensor 54 in communication with the controller 38. The sensor 54 may be disposed in any suitable location to provide data regarding one of the inputs. In certain embodiments, a plurality of the sensors 54 may be utilized to provide data regarding the plurality of the inputs. Therefore, if the user does not provide various information regarding one or more of the inputs, the alert system 12 may determine certain information from the sensor(s) 54 and prepare an alert for the user based on the information from the sensor(s) 54. For example, one or more sensors 54 may be coupled to the seat 20 to determine the weight of the user and determine the position of the seat 20. As other examples, one or more sensors 54 may be coupled to the rear view mirror 50, the accelerator pedal 48, the brake pedal 46, the steering wheel 44, the outside mirrors 52 to determine the height of the user and determine the position of the seat 20.

Hence, the controller 38 is configured to execute the instructions from the memory 42, via the processor 40. For example, the controller 38 may be a host machine or distributed system, e.g., a computer such as a digital computer or microcomputer, and, as the memory 42, tangible, non-transitory computer-readable memory such as read-only memory (ROM) or flash memory. The controller 38 may also have random access memory (RAM), electrically erasable programmable read-only memory (EEPROM), a high-speed clock, analog-to-digital (A/D) and/or digital-to-analog (D/A) circuitry, and any required input/output circuitry and associated devices, as well as any required signal conditioning and/or signal buffering circuitry. Therefore, the controller 38 may include all software, hardware, memory 42, algorithms, connections, sensors 54, etc., necessary to control and/or communicate with, for example, the indicator 22, the display 36A, the speaker 36B, the navigation system 34, the notification assembly 36, the sensors 54, the user interface, etc. As such, a control method for alerting the user, may be embodied as software or firmware associated with the controller 38. It is to be appreciated that the controller 38 may also include any device capable of analyzing data from various sensors 54, comparing data, making the necessary decisions required to control and/or communicate with, the indicator 22, the display 36A, the speaker 36B, the navigation system 34, the notification assembly 36, the sensors 54, the user interface, etc. Optionally, more than one controller 38 may be utilized.

The present disclosure also provides a method of alerting the user disposed on the seat 20. The user may be alerted via moving the seat 20. As one example, the alert may include massaging the user's back region and/or the user's leg region, thus improving the comfort of the user in the seat 20. As another example, the alert may include massaging the user's back region and/or the user's leg region to notify the user it is time to stop and exit the vehicle 10. By exiting the vehicle 10, the user may move to other positions besides sitting, which may improve the comfort of the user when returning to the seat 20. As yet another example, the alert may include changing the orientation of the lumbar region 24 relative to the bottom region 26 and/or changing the convexity of the lumbar region 24 and/or bottom region 26, thus improving the comfort of the user and/or notify the user it is time to stop and exit the vehicle 10.

Generally, the method includes storing data regarding the plurality of inputs via the controller 38 having the memory 42 and the processor 40. Therefore, the user may enter data regarding various inputs, or various inputs may be stored in the memory 42 of the controller 38 automatically through one or more of the sensors 54. For example, the user may enter information using the display 36A, which is stored in the memory 42 of the controller 38, and/or the sensors 54 may send information to the controller 38 to be stored in the memory 42.

The method also includes determining if the predetermined threshold is reached in light of the inputs. Generally, the predetermined threshold includes a predetermined duration of time. The predetermined duration of time may be based on one or more of the inputs. For example, the predetermined duration of time may be the amount of time the vehicle 10 travels from a starting point, may be the amount of time the vehicle 10 travels from a stopping point, or may be a set amount of time entered by the user.

The method also includes activating the indicator 22 of the seat 20 when the predetermined threshold is reached to alert the user. More specifically, in certain embodiments, activating the indicator 22 includes moving the seat 20 in response to activation of the massage apparatus 22A when the predetermined threshold is reached. As such, in various embodiments, moving the seat 20 includes moving at least one of the lumbar region 24 and the bottom region 26 of the seat 20 in response to activation of the massage apparatus 22A when the predetermined threshold is reached. In other embodiments, moving the seat 20 includes moving both of the lumbar region 24 and the bottom region 26 of the seat 20 in response to activation of the massage apparatus 22A when the predetermined threshold is reached. As yet additional embodiments, moving the seat 20 may include changing the orientation of the lumbar region 24 relative to the bottom region 26 and/or changing the convexity of the lumbar region 24 and/or bottom region 26. Therefore, the user is alerted when the seat 20 moves, and thus massages the user's body 14 as desired, or repositions the user's body as desired, and, if desired, indicates that it is time to stop the vehicle 10 and move around outside of the vehicle 10.

The method discussed above may be utilized whether or not the final destination of the vehicle 10 is known. Therefore, optionally, the user may store the final destination of the vehicle 10 before beginning the trip and the alert system 12 will determine whether an alert is required and if required, alert at the appropriate time(s). Otherwise, the user may begin the trip and the alert system 12 will collect and store various data and determine whether an alert is required and if required, alert at the appropriate time(s). Below are more detailed discussions of three situations that may utilize the method discussed above.

First is a discussion of utilizing the alert system 12 if the final destination is not provided to the controller 38 via the user. When the user sits on the seat 20, data about one or more of the inputs may be collected via the sensors 54 and communicated to the controller 38. Otherwise, the user may provide data about one or more of the inputs using the display 36A to enter the data, and this data is communicated to the controller 38. For example, the controller 38 may store data regarding the inputs for a “user A” and a “user B”, etc., and the respective user may select the desired stored user A or user B using the display 36A.

The method may include communicating a first stop location from a navigation system 34 to the controller 38. For example, the first stop location may be the starting point of the vehicle 10. As such, the controller 38 also collects information about the starting point through the navigation system 34.

The method may also include monitoring a current location of the vehicle 10 from the navigation system 34 to the controller 38 after communicating the first stop location. As such, as the vehicle 10 travels from the starting point, the navigation system 34 continues to monitor the location of the vehicle 10, and this information is communicated to the controller 38.

In this example, as discussed above, the final destination is not provided. As such, the controller 38 uses the provided and/or determined inputs to provide the predetermined threshold. In this example, the predetermined threshold includes a predetermined duration of time the vehicle 10 travels from the first stop location.

Once the predetermined threshold is reached, the controller 38 communicates with the indicator 22 and the notification assembly 36. As such, the indicator 22 will move the seat 20 and the notification assembly 36 will announce an upcoming location to stop the vehicle 10. The upcoming location is provided via the navigation system 34 and communicated to the controller 38. As such, the method may include communicating to the notification assembly 36 the upcoming location to stop the vehicle 10 when the predetermined duration of time is reached. In certain embodiments, communicating to the notification assembly 36 the upcoming location to stop includes displaying the upcoming location on the display 36A. Also in certain embodiments, communicating to the notification assembly 36 the upcoming location to stop includes vocalizing the upcoming location on the speaker 36B. Therefore, the upcoming location may be communicated by displaying the location and/or vocalizing the location.

The method may also include determining, upon reaching the upcoming location, whether the vehicle 10 stopped at the upcoming location. One or more of the sensors 54 may communicate with the controller 38 whether the user got off the seat 20 and/or a camera 56 may communicate with the controller 38 whether the user has been removed from the seat 20, and thus stopped the vehicle 10. The camera 56 may also detect whether a different user is disposed on the seat 20. If the vehicle 10 did not stop at the suggested location, the navigation system 34 will communicate to the controller 38 another upcoming location to stop the vehicle 10, and so on, until the vehicle 10 stops. As such, the method may include communicating to the notification assembly 36 another upcoming location to stop the vehicle 10 if the vehicle 10 bypassed the previous upcoming location. The indicator 22 may continue to move the seat 20 from the bypassed location to the new upcoming location, or the indicator 22 may stop moving the seat 20 after a predetermined amount of time after bypassing the location, or stop moving the seat 20 when the location is bypassed, and the indicator 22 may be reactivated when the next upcoming location to stop has been identified. If desired, the notification assembly 36 may be turned off if the user does not want to stop the vehicle 10.

If the vehicle 10 did stop at the suggested location, then that stop location is communicated to the controller 38. As such, the method may include communicating a second stop location if the vehicle 10 stopped upon reaching the upcoming location. The second stop location is collected via the navigation system 34 and communicated to the controller 38.

Then the method may include determining whether another stop is required if the predetermined duration of time is reached after reaching the second stop location. If another stop is not required, then the user will not be alerted. If another stop is required, then the user will be alerted. As such, the indicator 22 will move the seat 20 and the notification assembly 36 will announce another upcoming location to stop the vehicle 10. Therefore, the method may include communicating to the notification assembly 36 another upcoming location (second upcoming location) to stop the vehicle 10 when the predetermined duration of time is reached after reaching the second stop location. Again, the next upcoming location may be communicated to the user via displaying and/or vocalizing as discussed above.

Next, the method may include determining, upon reaching the second upcoming location, whether the vehicle 10 stopped at the second upcoming location. Again, one or more of the sensors 54 may communicate with the controller 38 whether the user got off the seat 20, and thus stopped the vehicle 10. If the vehicle 10 did not stop at the suggested location, the navigation system 34 will communicate to the controller 38 yet another upcoming location to stop the vehicle 10, and so on, until the vehicle 10 stops. As such, the method may include communicating to the notification assembly 36 yet another upcoming location to stop the vehicle 10 if the vehicle 10 bypassed the previous upcoming location. The indicator 22 may continue to move the seat 20 from the bypassed location to the new upcoming location, or the indicator 22 may stop moving the seat 20 after a predetermined amount of time after bypassing the location, or stop moving the seat 20 when the location is bypassed, and the indicator 22 may be reactivated when the next upcoming location to stop is approaching. If desired, the notification assembly 36 may be turned off if the user does not want to stop the vehicle 10.

Each of the routes that the vehicle 10 travels is communicated from the navigation system 34 to the controller 38 so the controller 38 may store the respective routes in the memory 42. In addition, the controller 38 may store the user's indicator 22 preferences (such as the amount of time the indicator 22 is activated, what regions 24, 26 and/or zones 28 of the seat 20 are activated, the number of times the indicator 22 is activated, the intensity of the indicator 22, etc.) during each of the routes. Also, the controller 38 stores the days of the week and times the routes are traveled. As such, the alert system 12 may learn the user's habits and preferences, and if the controller 38 determines that the vehicle 10 is traveling along a previously traveled route, then the controller 38 may cue that route until the vehicle 10 changes location to a new route. Therefore, the method may also include comparing routes to determine whether the current route exists.

Second is a discussion of utilizing the alert system 12 if the final destination is provided to the controller 38 via the user. As such, the user may provide the final destination through the display 36A or by speaking the final destination. If the final destination has been previously saved in the memory 42 of the controller 38, the user may select the saved route using the display 36A.

When the user sits on the seat 20, data about one or more of the inputs may be collected via the sensors 54 and communicated to the controller 38. Otherwise, the user may provide data about one or more of the inputs using the display 36A to enter the data, and this data is communicated to the controller 38. For example, the controller 38 may store data regarding the inputs for a “user A” and a “user B”, etc., and the respective user may select the desired stored user A or user B using the display 36A.

The method may include communicating a first stop location from a navigation system 34 to the controller 38. For example, the first stop location may be the starting point of the vehicle 10. As such, the controller 38 also collects information about the starting point through the navigation system 34.

The method may also include storing an ending location of the vehicle 10 in the navigation system 34. As such, the controller 38 also collects information about the final destination of the vehicle 10 through the navigation system 34.

The method may also include monitoring a current location of the vehicle 10 from the navigation system 34 to the controller 38 after communicating the first stop location. As such, as the vehicle 10 travels from the starting point, the navigation system 34 continues to monitor the location of the vehicle 10, and this information is communicated to the controller 38.

In this example, as discussed above, the final destination is provided. As such, the controller 38 uses the provided final destination and the provided and/or determined inputs to provide the predetermined threshold. In this example, the predetermined threshold includes a predetermined duration of time the vehicle 10 travels between the first stop location and the ending location. As such, if the controller 38 determines that one or more stops are required before reaching the final destination, one or more alerts will be created.

Once the predetermined threshold is reached, the controller 38 communicates with the indicator 22 and the notification assembly 36. As such, the indicator 22 will move the seat 20 and the notification assembly 36 will announce an upcoming location to stop the vehicle 10. The upcoming location is provided via the navigation system 34 and communicated to the controller 38. As such, the method may include communicating to the notification assembly 36 the upcoming location to stop the vehicle 10 when the predetermined duration of time is reached. In certain embodiments, communicating to the notification assembly 36 the upcoming location to stop includes displaying the upcoming location on the display 36A. Also in certain embodiments, communicating to the notification assembly 36 the upcoming location to stop includes vocalizing the upcoming location on the speaker 36B. Therefore, the upcoming location may be communicated by displaying the location and/or vocalizing the location.

The method may also include determining, upon reaching the upcoming location, whether the vehicle 10 stopped at the upcoming location. Again, one or more of the sensors 54 may communicate with the controller 38 whether the user got off the seat 20 and/or the camera 56 may communicate with the controller 38 whether the user has been removed from the seat 20, and thus stopped the vehicle 10. The camera 56 may also detect whether a different user is disposed on the seat 20. If the vehicle 10 did not stop at the suggested location, the navigation system 34 will communicate to the controller 38 another upcoming location to stop the vehicle 10, and so on, until the vehicle 10 stops. As such, the method may include communicating to the notification assembly 36 another upcoming location to stop the vehicle 10 if the vehicle 10 bypassed the previous upcoming location. The indicator 22 may continue to move the seat 20 from the bypassed location to the new upcoming location, or the indicator 22 may stop moving the seat 20 after a predetermined amount of time after bypassing the location, or stop moving the seat 20 when the location is bypassed, and the indicator 22 may be reactivated when the next upcoming location to stop is approaching. If desired, the notification assembly 36 may be turned off if the user does not want to stop the vehicle 10.

If the vehicle 10 did stop at the suggested location, then that stop location is communicated to the controller 38. As such, the method may include communicating a second stop location if the vehicle 10 stopped upon reaching the upcoming location. The second stop location is collected via the navigation system 34 and communicated to the controller 38.

Then the method may include determining whether another stop is required after reaching the second stop location. More specifically, if the predetermined duration of time will be reached again before arriving at the final destination, then another alert will be created. If another stop is not required, then the user will not be alerted. If another stop is required, then the user will be alerted. As such, the indicator 22 will move the seat 20 and the notification assembly 36 will announce another upcoming location to stop the vehicle 10. Therefore, the method may include communicating to the notification assembly 36 another upcoming location (second upcoming location) to stop the vehicle 10 after reaching the second stop location. Hence, the notification assembly 36 announces another upcoming location (second upcoming location) to stop the vehicle 10 when the predetermined duration of time is reached again before reaching the final destination. Again, the next upcoming location may be communicated to the user via displaying and/or vocalizing as discussed above.

Next, the method may include determining, upon reaching the second upcoming location, whether the vehicle 10 stopped at the second upcoming location. If the vehicle 10 did not stop at the suggested location, the navigation system 34 will communicate to the controller 38 yet another upcoming location to stop the vehicle 10, and so on, until the vehicle 10 stops. As such, the method may include communicating to the notification assembly 36 yet another upcoming location to stop the vehicle 10 if the vehicle 10 bypassed the previous upcoming location. The indicator 22 may continue to move the seat 20 from the bypassed location to the new upcoming location, or the indicator 22 may stop moving the seat 20 after a predetermined amount of time after bypassing the location, or stop moving the seat 20 when the location is bypassed, and the indicator 22 may be reactivated when the next upcoming location to stop is approaching. If desired, the notification assembly 36 may be turned off if the user does not want to stop the vehicle 10.

Each of the routes that the vehicle 10 travels is communicated from the navigation system 34 to the controller 38 so the controller 38 may store the respective routes in the memory 42. In addition, the controller 38 may store the user's indicator 22 preferences (such as the amount of time the indicator 22 is activated, what regions 24, 26 and/or zones 28 of the seat 20 are activated, the number of times the indicator 22 is activated, the intensity of the indicator 22, etc.) during each of the routes. Also, the controller 38 stores the provided final destination. Therefore, the method may also include comparing routes to determine whether the current route exists.

Third is a discussion of utilizing the alert system 12 if the final destination is not provided, and the user chooses the predetermined threshold to activate the indicator 22. Therefore, the method may include storing data regarding an amount of time the indicator 22 is activated, and the method may also include storing data regarding an amount of intensity of the indicator 22. The method may also include storing data regarding how much time passes until the indicator 22 moves the seat 20, how long the indicator 22 is activated, what regions 24, 26 and/or zones 28 of the seat 20 are activated, the number of times the indicator 22 is activated, the intensity of the indicator 22, etc. If using this alert in a vehicle application, the notification assembly 36 does not announce any upcoming location to stop the vehicle 10.

In this example, the predetermined threshold includes a set duration of time. Again, the user presets how much time will pass before starting one or more of the alerts relative to a starting point.

The method may include communicating a first stop location from a navigation system 34 to the controller 38. For example, the first stop location may be the starting point of the vehicle 10. As such, the set duration of time proceeds from the starting point. The method may include activating the indicator 22 of the seat 20 includes activating the indicator 22 when the set duration of time passes after the first stop location. As such, the controller 38 will communicate to the indicator 22 to move the seat 20 for the set amount of time when the set duration of time passes.

The method may also include determining whether another activation of the indicator 22 is required after activating the indicator 22 when the set duration of time passes. For example, the indicator 22 may be activated multiple times during one trip if the user does not stop for an extended amount of time and the set duration of time passes multiple times.

It is to be appreciated that the order or sequence of performing the method as discussed above is for illustrative purposes and the method may include other features.

While the best modes and other embodiments for carrying out the disclosure have been described in detail, those familiar with the art to which this disclosure relates will recognize various alternative designs and embodiments for practicing the disclosure within the scope of the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

What is claimed is:

1. A method of alerting a user disposed on a seat; the method comprising:
storing data regarding a plurality of inputs via a controller having a memory and a processor;
determining if a predetermined threshold is reached in light of the inputs; and
activating an indicator of the seat when the predetermined threshold is reached to alert the user.

2. The method as set forth in claim 1 wherein:
the indicator includes a massage apparatus coupled to the seat, and the massage apparatus is configured to move the seat; and
activating the indicator includes moving the seat in response to activation of the massage apparatus when the predetermined threshold is reached.

3. The method as set forth in claim 2 wherein:
the seat includes a lumbar region and a bottom region transverse to the lumbar region, and wherein the massage apparatus is coupled to at least one of the lumbar region and the bottom region; and
moving the seat includes moving at least one of the lumbar region and the bottom region of the seat in response to activation of the massage apparatus when the predetermined threshold is reached.

4. The method as set forth in claim 3 wherein moving the seat includes moving both of the lumbar region and the bottom region of the seat in response to activation of the massage apparatus when the predetermined threshold is reached.

5. The method as set forth in claim 1:
wherein the seat is disposed in a passenger compartment of a vehicle;
wherein the inputs include at least one of a weight, a height and a position of the seat;
further comprising communicating a first stop location from a navigation system to the controller;
further comprising monitoring a current location of the vehicle from the navigation system to the controller after communicating the first stop location;
wherein the predetermined threshold includes a predetermined duration of time the vehicle travels from the first stop location; and
further comprising communicating to a notification assembly an upcoming location to stop the vehicle when the predetermined duration of time is reached.

6. The method as set forth in claim 5 further comprising:
determining, upon reaching the upcoming location, whether the vehicle stopped at the upcoming location;
communicating a second stop location if the vehicle stopped upon reaching the upcoming location;
determining whether another stop is required if the predetermined duration of time is reached after reaching the second stop location; and
communicating to the notification assembly another upcoming location to stop the vehicle when the predetermined duration of time is reached after reaching the second stop location.

7. The method as set forth in claim 5 further comprising:
determining, upon reaching the upcoming location, whether the vehicle stopped at the upcoming location; and
communicating to the notification assembly another upcoming location to stop the vehicle if the vehicle bypassed the upcoming location.

8. The method as set forth in claim 5 wherein the notification assembly includes a display, and wherein communicating to the notification assembly the upcoming location to stop includes displaying the upcoming location on the display.

9. The method as set forth in claim 5 wherein the notification assembly includes a speaker, and wherein communicating to the notification assembly the upcoming location to stop includes vocalizing the upcoming location on the speaker.

10. The method as set forth in claim 1:
wherein the seat is disposed in a passenger compartment of a vehicle;
wherein the inputs include at least one of a weight, a height and a position of the seat;
further comprising communicating a first stop location from a navigation system to the controller;
further comprising storing an ending location of the vehicle in the navigation system;
wherein the predetermined threshold includes a predetermined duration of time the vehicle travels between the first stop location and the ending location;
further comprising monitoring a current location of the vehicle from the navigation system to the controller after communicating the first stop location; and
further comprising communicating to a notification assembly an upcoming location to stop the vehicle when the predetermined duration of time is reached.

11. The method as set forth in claim 10 further comprising:
determining, upon reaching the upcoming location, whether the vehicle stopped at the upcoming location;
communicating a second stop location if the vehicle stopped upon reaching the upcoming location;
determining whether another stop is required after reaching the second stop location; and
communicating to the notification assembly another upcoming location to stop the vehicle after reaching the second stop location.

12. The method as set forth in claim 1:
wherein the seat is disposed in a passenger compartment of a vehicle;
wherein the inputs include at least one of a weight, a height and a position of the seat;
wherein the predetermined threshold includes a set duration of time;
further comprising communicating a first stop location from a navigation system to the controller;
further comprising storing data regarding an amount of time the indicator is activated and an amount of intensity of the indicator; and
wherein activating the indicator of the seat includes activating the indicator when the set duration of time passes after the first stop location.

13. The method as set forth in claim 12 further comprising determining whether another activation of the indicator is required after activating the indicator when the set duration of time passes.

14. The method as set forth in claim 1:
wherein the seat is disposed in a passenger compartment of a vehicle;
further comprising determining a location to stop the vehicle when the predetermined threshold is reached; and
further comprising announcing the location to stop the vehicle via a notification assembly.

15. The method as set forth in claim 14 further comprising:
determining, upon reaching the location, whether the vehicle stopped at the location;
communicating another location to stop if the vehicle bypassed the location; and
communicating to the notification assembly another location to stop the vehicle after reaching the location.

16. An alert system comprising:
a seat including an indicator;
a controller in communication with the indicator, and the controller includes a processor and a memory having recorded instructions for alerting a user, and wherein the controller is configured to:
store data regarding a plurality of inputs;
determine if a predetermined threshold is reached in light of the inputs; and
activate an indicator of a seat when the predetermined threshold is reached to alert the user.

17. The alert system as set forth in claim 16 wherein the seat includes a lumbar region and a bottom region transverse to the lumbar region, and wherein the indicator is coupled to at least one of the lumbar region and the bottom region.

18. The alert system as set forth in claim 17 wherein the indicator includes a massage apparatus configured to move at least one of the lumbar region and the bottom region in response to the predetermined threshold being reached.

19. The alert system as set forth in claim 18:
wherein the seat is disposed in a passenger compartment of a vehicle.
wherein the inputs include at least one of a weight, a height and a position of the seat;
wherein a first stop location is communicated from a navigation system to the controller;
a current location of the vehicle from the navigation system is monitored via the controller after the first stop location is communicated to the controller;
wherein the predetermined threshold includes a predetermined duration of time the vehicle travels from the first stop location; and
a notification assembly announces an upcoming location to stop the vehicle when the predetermined duration of time is reached.
